(19) United States
(12) Patent Application Publication
(10) Pub. No.: US 2025/0306322 A1
(43) Pub. Date: Oct. 2, 2025

(54) POINT OF CONNECTION BACKBOARD ASSEMBLY FOR TELECOMMUNICATIONS EQUIPMENT

(71) Applicant: c/o AFL Telecommunications LLC, Duncan, SC (US)

(72) Inventor: Aran James Russell Davidson, Chesham (GB)

(21) Appl. No.: 18/798,934

(22) Filed: Aug. 9, 2024

Related U.S. Application Data
(60) Provisional application No. 63/573,199, filed on Apr. 2, 2024.

(51) Int. Cl. G02B 6/44; G02B 6/36

(52) U.S. Cl. CPC G02B 6/44524; G02B 6/3644

(57) ABSTRACT

A backboard assembly for telecommunications equipment mounting includes a backboard having a wall through which an opening is formed. The opening forms an elongated slot. A face forming a detent is positioned offset from the opening and the wall. A fastener assembly includes a mount wall and a member extending therefrom toward the opening at the backboard. The member includes a wing extending co-directional to the wall at the opening of the backboard. The wing positions between the face and the wall when the member of the fastener assembly is extended through the opening of the backboard.

### PRIORITY STATEMENT

The present disclosure claims the benefit of priority to U.S. provisional patent application No. 63/573,199, filed Apr. 2, 2024, the disclosure of which is incorporated by reference herein in its entirety.

### FIELD

The present disclosure relates generally to closures and cable management apparatuses for telecommunications equipment, such as fiber optic systems.

### BACKGROUND

Within Fiber-To-The-Home (FTTH) Networks, operators typically build in various junctions points or demarcation points to distribute an optical fiber network to multiple dwellings. Demarcation points can typically be housed inside a protective cabinet, a dome enclosure, a pedestal enclosure, or wall box, situated at the side of the road. Inside the cabinet is an assembly of managed optical fiber connection points that provide housing for optical fiber splicing, optical splitters, optical fiber connections, and cable/duct management. The use of these demarcation points allows operators to connect users to the optical fiber network.

An apparatus that facilitates routing fiber/cable inside a protective cabinet, dome enclosure, pedestal enclosure, or wall box would be beneficial and advantageous. Additionally, or alternatively, an apparatus facilitating mount and fastening of fiber/cable management, splicing, and cassette modules would be beneficial and advantageous.

### BRIEF DESCRIPTION

Aspects and advantages of the invention will be set forth in part in the following description, or may be apparent from the description, or may be learned through practice of the invention.

An aspect of the present disclosure is directed to a backboard assembly for telecommunications equipment mounting. The backboard assembly includes a backboard having a wall through which an opening is formed. The opening forms an elongated slot. A face forming a detent is positioned offset from the opening and the wall. A fastener assembly includes a mount wall and a member extending therefrom toward the opening at the backboard. The member includes a wing extending co-directional to the wall at the opening of the backboard. The wing positions between the face and the wall when the member of the fastener assembly is extended through the opening of the backboard.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an embodiment of a backboard assembly in accordance with aspects of the present disclosure.

FIG. 2A provides a perspective view of an embodiment of a backboard of the backboard assembly in accordance with aspects of the present disclosure.

FIG. 2B provides a perspective view of an embodiment of a backboard of the backboard assembly in accordance with aspects of the present disclosure.

FIG. 3 provides a perspective view of an embodiment of a backboard of a backboard assembly in accordance with aspects of the present disclosure.

FIG. 4 provides a perspective view of an embodiment of the backboard assembly in a first exemplary configuration accordance with aspects of the present disclosure.

FIG. 5 provides a perspective view of an embodiment of the backboard assembly in a second exemplary configuration accordance with aspects of the present disclosure.

FIG. 6 provides a perspective view of an embodiment of the backboard assembly in a third exemplary configuration accordance with aspects of the present disclosure.

FIG. 7 provides a perspective view of an embodiment of a backboard assembly in accordance with aspects of the present disclosure.

FIG. 8 provides a front view of an embodiment of a backboard assembly in accordance with aspects of the present disclosure.

FIG. 9A provides a perspective view of an embodiment of a fastener assembly in accordance with aspects of the present disclosure.

FIG. 9B provides a front view of a portion of the embodiment of the fastener assembly of FIG. 9A in accordance with aspects of the present disclosure.

FIG. 9C provides a rear perspective view of a portion of the embodiment of the fastener assembly of FIG. 9A in accordance with aspects of the present disclosure.

FIG. 10A provides a front perspective view of a portion of the backboard of the backboard assembly in accordance with aspects of the present disclosure.

FIG. 10B provides a rear perspective view of a portion of the backboard of the backboard assembly in accordance with aspects of the present disclosure.

FIG. 11A provides an exploded rear perspective view of a portion of the backboard depicting an exemplary method for assembling an embodiment of the fastener assembly to an embodiment of the backboard in accordance with aspects of the present disclosure.

FIG. 11B provides an assembled rear perspective view of the portion of the backboard of FIG. 11A in accordance with aspects of the present disclosure.

FIG. 12 provides a perspective view of an embodiment of a fastener assembly in accordance with aspects of the present disclosure.

FIG. 13A provides an exemplary perspective view of an embodiment of a tray attached to an embodiment of a fastener assembly in accordance with aspects of the present disclosure.

FIG. 13B provides a detailed view of a portion of the tray-fastener assembly of FIG. 13A in accordance with aspects of the present disclosure.

FIG. 13C provides a perspective view of an exemplary embodiment of a tray in accordance with aspects of the present disclosure.

FIG. 13D provides an exploded view of an embodiment of the tray of FIG. 13C in accordance with aspects of the present disclosure.

FIG. 13E provides detailed view of an embodiment of the tray of FIG. 13A in accordance with aspects of the present disclosure.

FIG. 13F provides detailed view of an embodiment of the tray of FIG. 13A in accordance with aspects of the present disclosure.

FIG. 14 provides a perspective view of an embodiment of a modular cassette chassis assembly in accordance with aspects of the present disclosure.

FIG. 15A provides a front perspective view of an embodiment of a fastener assembly in accordance with aspects of the present disclosure.

FIG. 15B provides a side view of the embodiment of the fastener assembly of FIG. 15A in accordance with aspects of the present disclosure.

FIG. 15C provides a rear perspective view of the embodiment of the fastener assembly of FIG. 15A in accordance with aspects of the present disclosure.

FIG. 15D provides an exploded front perspective view of a portion of a backboard depicting an exemplary method for assembling an embodiment of the fastener assembly of FIGS. 15A-15C in accordance with aspects of the present disclosure.

FIG. 15E provides an assembled front perspective view of the portion of the backboard of FIG. 15D in accordance with aspects of the present disclosure.

FIG. 15F provides an assembled rear perspective view of the portion of the backboard of FIG. 15D in accordance with aspects of the present disclosure.

FIG. 16 provides an exemplary embodiment of a backboard assembly in accordance with aspects of the present disclosure.

FIG. 17 provides an exemplary embodiment of a backboard assembly in accordance with aspects of the present disclosure.

FIG. 18A provides a front perspective view of an exemplary embodiment of a backboard assembly in accordance with aspects of the present disclosure.

FIG. 18B provides a rear perspective view of the exemplary embodiment of the backboard assembly of FIG. 18A in accordance with aspects of the present disclosure.

FIG. 19A provides a perspective view of an exemplary embodiment of a cassette module of the backboard assembly in accordance with aspects of the present disclosure.

FIG. 19B provides a plan view of an exemplary embodiment of the cassette module of FIG. 19A in a first routing configuration in accordance with aspects of the present disclosure.

FIG. 19C provides a plan view of an exemplary embodiment of the cassette module of FIG. 19A in a second routing configuration in accordance with aspects of the present disclosure.

FIG. 19D provides an internal view of an exemplary embodiment of the cassette module of FIG. 19A in accordance with aspects of the present disclosure.

FIG. 19E provides a plan view of an exemplary embodiment of the cassette module of FIG. 19A from an opposing side from FIG. 19B and FIG. 19C in accordance with aspects of the present disclosure.

FIG. 20 provides an exemplary embodiment of a cassette chassis of the backboard assembly in accordance with aspects of the present disclosure.

FIG. 21A provides a perspective view of an exemplary embodiment of a cable manifold of the backboard assembly in accordance with aspects of the present disclosure.

FIG. 21B provides an exploded view of the embodiment of the cable manifold of FIG. 21A in accordance with aspects of the present disclosure.

FIG. 22 provides a perspective view of an exemplary embodiment of a duct tie point of the backboard assembly in accordance with aspects of the present disclosure.

FIG. 23 provides a perspective view of an exemplary embodiment of a cable manager of the backboard assembly in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Ranges provided herein are inclusive of their end points. For instance, a range of 1 to 100 includes 1 and 100.

Terms of approximation, such as “about,” “generally,” “approximately,” or “substantially,” include values within a ten percent full scale error from a lowest value embodiment to a highest value embodiment. For instance, an embodiment including a range from approximately 10 to approximately 100 with a ten percent full scale error may include values from 1 to 109.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

A mutually orthogonal reference vertical direction V, horizontal or lateral direction L, and depth direction D are provided in the drawings.

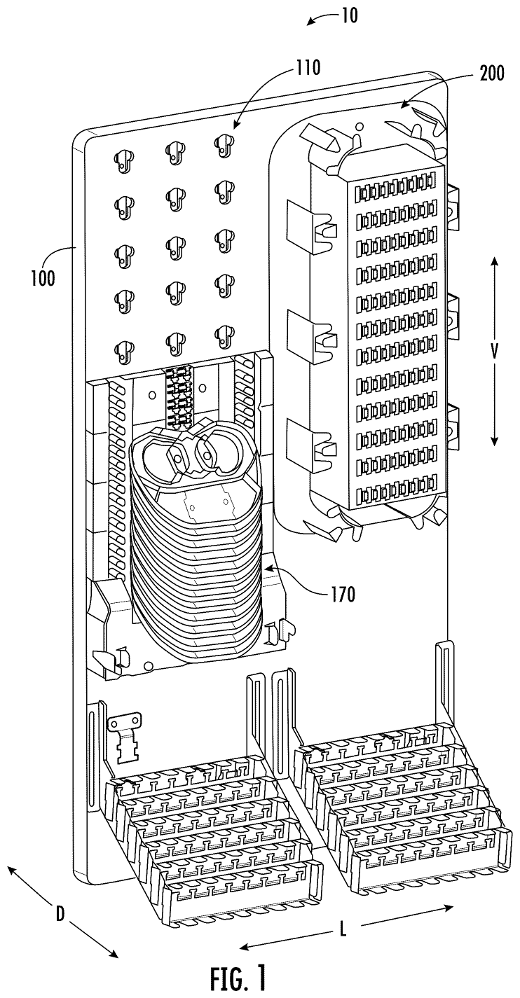

Referring now to the drawings, FIG. 1 provides a perspective view of a point of connection backboard assembly 10 for telecommunications equipment in accordance with embodiments of the present disclosure. Embodiments depicted and described herein of a point of connection backboard assembly 10 and fastener 122 apparatus are provided that may address one or more of the aforementioned issues. Embodiments of the backboard assembly 10, such as provided in exemplary drawings herein, include a backboard 100 and a fastener assembly 150. The fastener assembly 150 may form a portion of one or more telecommunications equipment structures of the backboard assembly 10, such as a splice tray/raceway mount, a modular cassette chassis assembly 200 (e.g., modular cassette chassis with integrated cable management structures), a cable manifold, one or more duct tie points, and a splitter/cassette optical assembly.

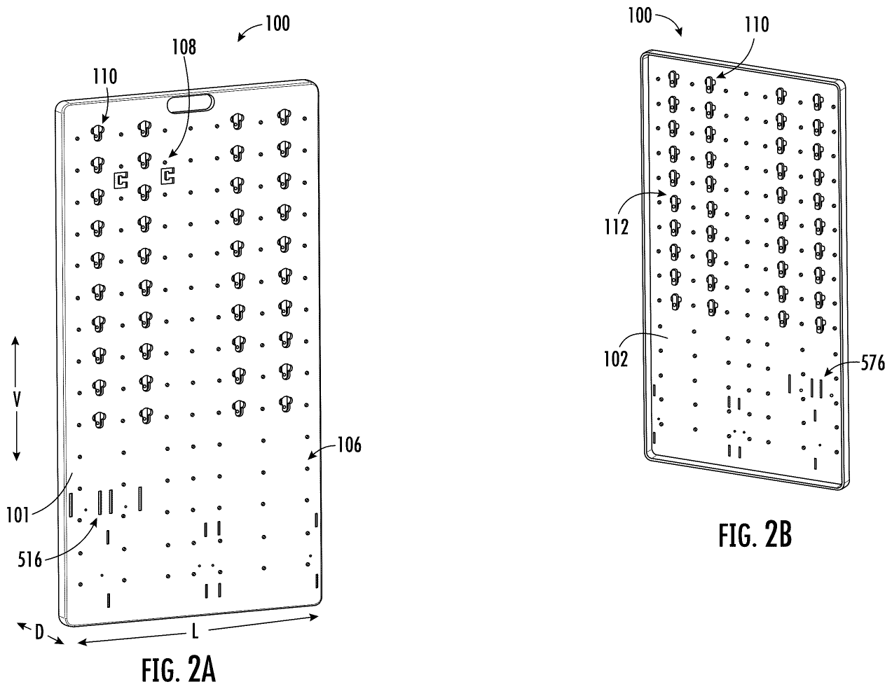

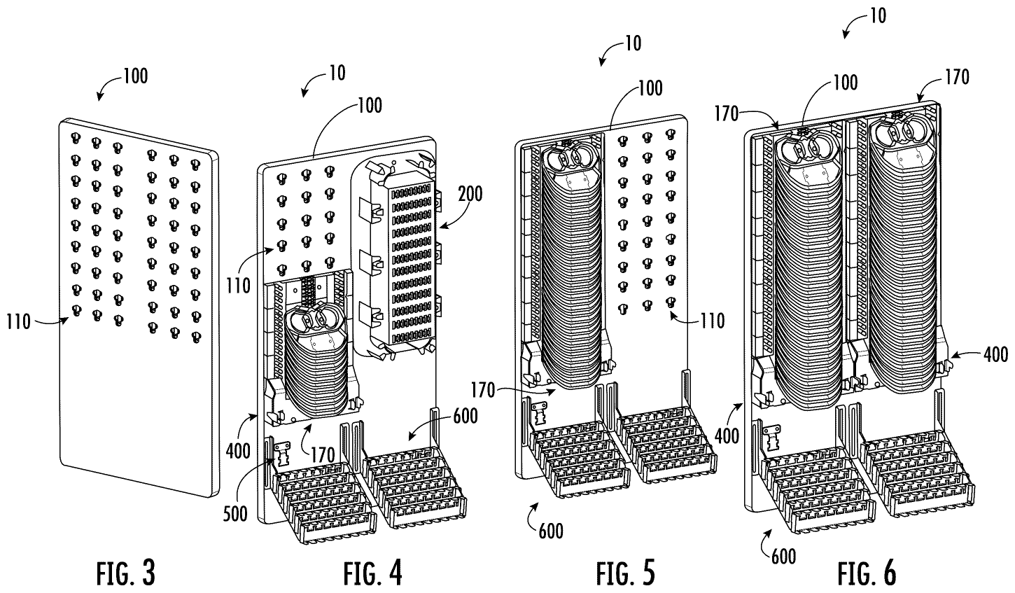

Referring to FIGS. 2A-2B, the backboard 100 includes a plurality of mount positions. The mount positions are formed from openings 110 facilitating various configurations of backboard assembly 10 using a common backboard 100. Referring to FIGS. 3-6, various configurations such as described herein may include the backboard 100 (e.g., FIG. 3) common across the configurations. For instance, configurations of backboard assembly 10 may include, but are not limited to, a splice tray stack with modular cassette chassis assembly 200 with integrated cable management (e.g., FIG. 4), splice tray stack only (e.g., FIG. 5), or double splice tray stack (e.g., FIG. 6), or combinations thereof. In various embodiments, the backboard 100 may be symmetrical in the vertical plane, such as may facilitate mounting components in an alternate symmetric position to the embodiments depicted in FIGS. 2-5.

In various embodiments, the backboard assembly 10 may include a desired combination of one or more modular cassette chassis, splice tray/raceway components, or both, (e.g., depicted in FIGS. 3-6). For instance, where a modular cassette chassis with integrated cable managers is not required, one or more splice tray/raceway components can be attached to the backboard 100 (e.g., depicted in FIGS. 5-6). As such, the same backboard 100 can be used across multiple configurations, in contrast to known backboard 100 or cabinet apparatuses. Additionally, or alternatively, the backboard, mount positions, and fasteners such as provided herein may overcome issues associated with various geometries of a modular cassette chassis, such as may result from an absence of industry-standard geometry of mounting optical patch cassettes into chassis. Embodiments of the backboard 100 provided herein may facilitate exchanging chassis designs and geometries at the backboard 100 relative to the cassette geometry that the chassis will house.

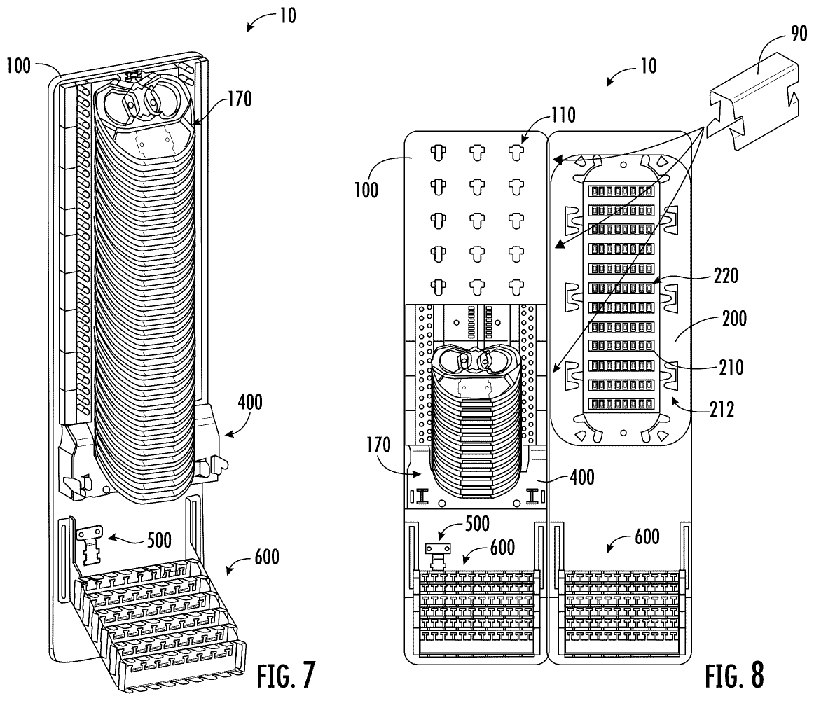

Referring to FIGS. 7-8, an embodiment of the backboard assembly 10 including a partial-width (e.g., half-width) modular backboard 100 is provided. The embodiment depicted in FIGS. 7-8 may be configured substantially similarly as the embodiments depicted in FIGS. 1-6 (e.g., a full-width backboard 100). Referring to FIGS. 7-8, a fitting 90 may fasten two or more partial-width backboards 100. The fitting may include, but is not limited to, a screw fitting, an integrated plastic snap together fitting, or panel edge clip. A partial-width backboard 100 may facilitate additional configuration flexibility, such as by just using one backboard 100 for a splice tray stack, or two or more of the same backboards 100, or two different backboards 100 with alternate functionality or configuration. Backboards 100 may be affixed together in pluralities greater than two, such as may facilitate further expansion for larger configurations. Partial-width backboards 100 may additionally, or alternatively, reduce costs associated to tooling.

Embodiments of the backboard 100 may be formed of a plastic polymer material. The plastic polymer material may include a thermoplastic polymer material. The thermoplastic polymer material may include acrylonitrile butadiene styrene (ABS). A method for construction may include an injection molding process. However, it should be appreciated that other forming, machining, or joining processes, or combinations thereof, may be utilized to construct the backboard 100 and backboard assembly 10.

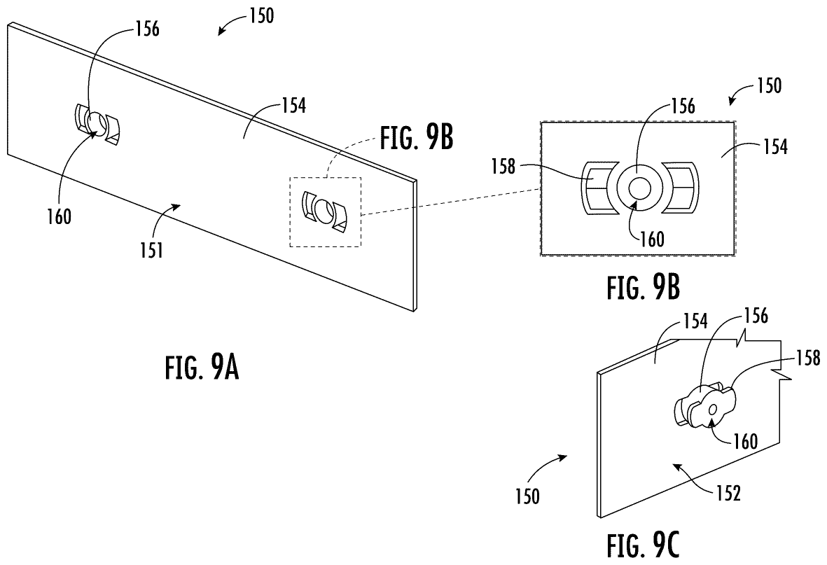

Referring now to FIGS. 9A-9C, FIGS. 10A-10B, FIGS. 11A-11B, and FIG. 12, detailed views of the backboard 100 and fastener assembly 150 are provided. Embodiments of the fastener assembly 150 may be included at the splice tray/raceway mount, modular chassis, or other telecommunications equipment apparatus. Embodiments of the backboard 100 and fastener assembly 150 may provide a drop-in mounting structure at the splice tray/raceway mount or modular chassis or other telecommunications equipment.

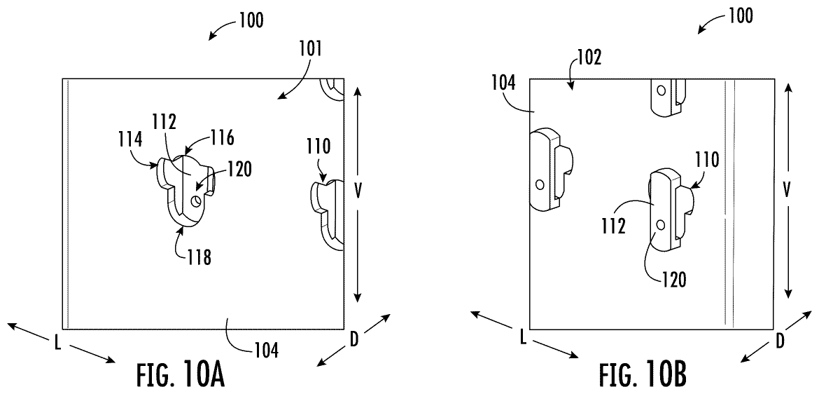

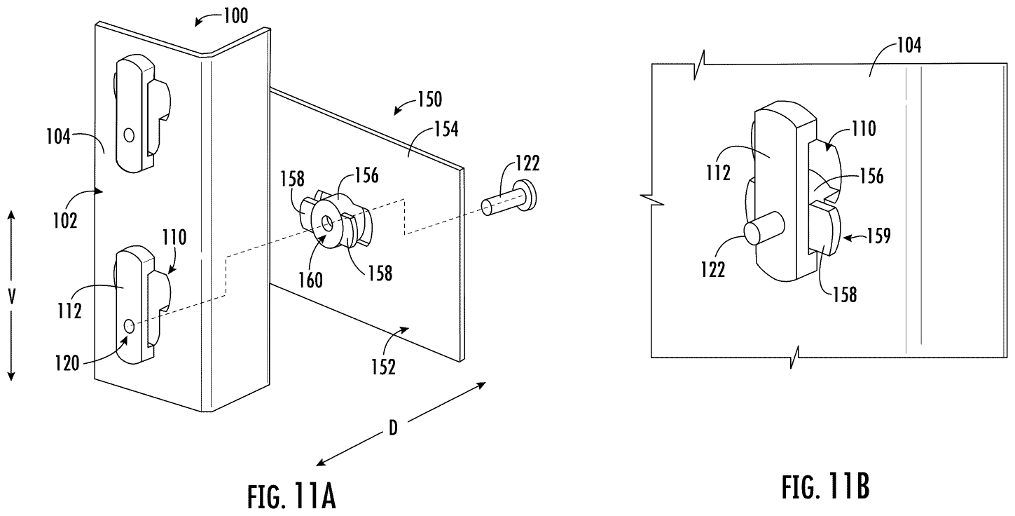

Referring to FIGS. 10A-10B, the backboard 100 includes a backboard wall 104 through which an opening 110 is formed. In various embodiments, the wall includes a plurality of openings 110 forming a plurality of mount positions that may facilitate assembly and retention of the fastener assembly 150 to the backboard 100. Assembly and retention of the fastener assembly 150 included at one or more of the splice tray/raceway mount or modular cassette chassis assembly 200 provides retention of telecommunications equipment to the backboard 100. The plurality of mount positions may form integrated drop-in mounting points facilitating assembly and retention of telecommunications equipment structures.

The opening 110 forming the mount position forms an elongated slot, such as extending along a vertical direction V through the backboard wall 104. The opening 110 forming the elongated slot extending along the vertical direction V includes a top end 116 and a bottom end 118 of the slot. A keyhole 114 extends at the opening 110 along the lateral direction L, such as from the top end 116.

The mount position at the backboard wall 104 includes the keyhole 114 at the opening 110 forming a laterally or horizontally-extended aperture corresponding substantially to a horizontally-extending tab or wing 158, such as further depicted and described in regard to FIGS. 9A-9C. A recessed face 112 forms a detent along a depth direction D. The face 112 forming the detent is positioned offset (e.g., offset along the depth direction D) from the opening 110 and the backboard wall 104. The face 112 may extend along the vertical direction V from the bottom end 118 to the top end 116 of the opening 110 forming the elongated slot.

Referring to FIGS. 9A-9C, embodiments of the fastener assembly 150 include a mount wall 154 including a body or member 156 (e.g., a tube, cone, or substantially cylindrical structure) extending therefrom. The body or member 156 includes a central bore or opening 160 configured to receive a mechanical fastener (e.g., screw, bolt, shank, threaded shank, etc.). A tab or wing 158 extends substantially horizontally from the body. For instance, two or more tabs may extend laterally or horizontally from the body. The tab or wing 158 may provide retention front to back (e.g., along depth direction D).

For instance, the member 156 may include a tube from which the wing 158 extends along the lateral direction L. The tube may correspond in outer dimension (e.g., outer diameter) to a portion of the opening 110 forming the elongated slot along the vertical direction V. The tab or wing 158 may correspond in extension along the lateral direction L to the keyhole 114 of the opening 110. The wing 158 may extend along the lateral direction L greater than the outer dimension of the tube. When the member 156 including the wing 158 is translated along the vertical direction V, movement of the wing 158 is inhibited along the depth direction D by the rear side 102 of the backboard wall 104.

The tab or wing 158 of the fastener assembly 150 may correspond in extension along the lateral direction L to the keyhole 114 of the opening 110 of the backboard 100, such as to permit entry of the wing 158 through the backboard wall 104 through the front side 101 and rear side 102.

In various embodiments, the tab or wing 158 is formed to include an interference fit with the backboard 100, such as between the backboard wall 104 and the recessed face 112. Referring to FIG. 11B, in some embodiments, the wing 158, the backboard wall 104, or both contour to include a ramped profiled edge 159 to form an interference fit. In some embodiments, the wing 158, or a portion thereof, adjacent to the backboard wall 104 is ramped at the edge 159 to form the interference fit against the rear side 102 of the backboard wall 104. In still some embodiments, the face 112 is offset from the backboard wall 104 corresponding to a thickness of the wing 158 to form an interference fit when the wing 158 is positioned between the face 112 and the backboard wall 104.

In some embodiments, the recessed face 112 may include a fastener opening 120 to accept a mechanical fastener. The fastener 122 may include a mechanical fastener, such as a locking screw, bolt, threaded shank, pin, rod, or other mechanical fastener. For instance, a vertical stack of splice tray/raceway mounts may only require a top component fastened with a mechanical fastener (e.g., a screw, bolt, or other threaded shank) to secure and fasten all components vertically below the top component. In various embodiments, the modular chassis can be fully secured to the backboard 100 using one mechanical fastener.

In some embodiments, the fastener opening 120 is positioned along the vertical direction V proximate to the bottom end 118 of the opening 110, such as to align the fastener opening 120 and fastener 122 to a position of tab or wing 158 constrained between the face 112 and the backboard wall 104 along the depth direction D.

FIGS. 11A-11B depict an exemplary method for assembling the fastener assembly 150 at the backboard 100. The body or member 156 extending from the mount wall 154 forms a male interface configured to extend through a corresponding geometry at the backboard 100 forming a female interface. The body is articulatable along the vertical direction V through the opening 110. Tabs or wings 158, when extended through the opening 110, form a detent limiting movement of the mount wall 154 along the depth direction D. The recessed face 112 may additionally form a detent limiting movement of the mount wall 154. For example, the tab or wing 158 is positioned between the recessed face 112 and the backboard wall 104 when the member 156 is extended through the opening 110. The wing 158 positioned between the face 112 and the backboard wall 104 may further be translated along the vertical direction V to the bottom end 118 of the opening 110, such that movement of the tab or wing 158 is constrained by the face 112 and the backboard wall 104 along the depth direction D. The recessed face 112 may further include arms limiting movement of the body and mount wall 154 along the vertical direction V. The mechanical fastener may extend through the opening 110 to form an additional fixing point of the mount wall 154 to the backboard 100.

In various embodiments, the backboard wall 104 may generally include a front side 101 and a rear side 102. The mount wall 154 may generally include a front side 151 and a rear side 152. The body or member 156 extends from the rear side 152 of the mount wall 154, such that the rear side 152 of the mount wall 154 abuts the front side 101 of the backboard wall 104 when the wing 158 is positioned between the face 112 and the backboard wall 104. The recessed face 112 extends from the rear side 102 of the backboard wall 104. In still various embodiments, the mechanical fastener 122 is extendable from the front side 151 of the mount wall 154 through the member 156 into the fastener opening 120 at the recessed face 112.

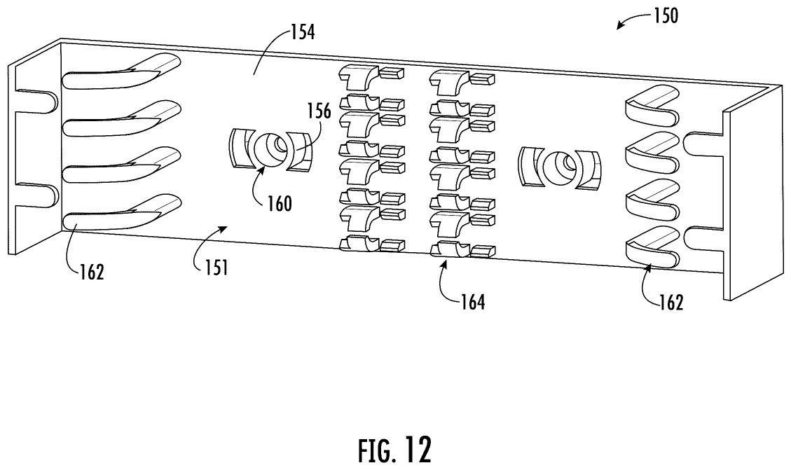

FIG. 12 depicts an exemplary embodiment of the fastener assembly 150 such as described in regard to FIGS. 9A-11B. Fastener assembly 150 may further include a raceway member 162, such as for fiber management and routing. Raceway feature 162 includes a wall extending from the mount wall 154. The raceway member 162 may include the wall contoured, such as to form a hook at which cables or fibers may be retained at the fastener assembly 150.

In various embodiments, fastener assembly 150 may include a tray mounting member 164, such as to receive a tray 170 (e.g., fiber optic splitter/splice tray). The tray mounting member 164 form clips, grips, or hinges configured to receive a pivot mechanism. Tray 170 may include a mount member 172, such as a rod or hinge forming a pivot mechanism, receivable into a channel formed at the tray mounting member 164. The tray mount member 172 may be rotatably attached at the tray mounting member 164 at the mount wall 154 of the fastener assembly 150 to facilitate rotation of the tray 170 relative to the fastener assembly 150.

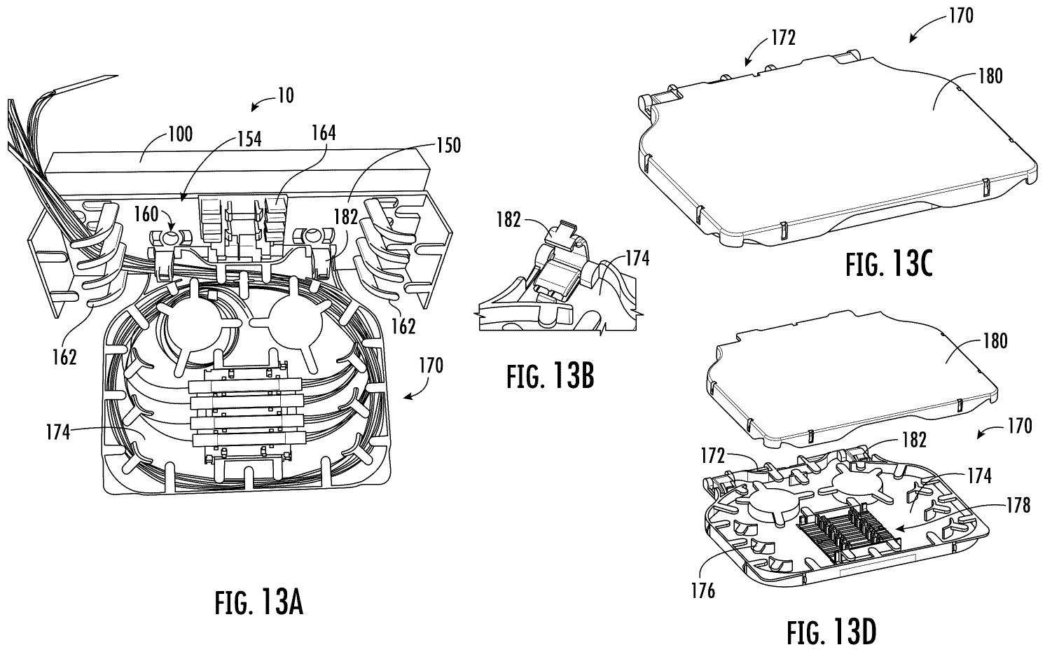

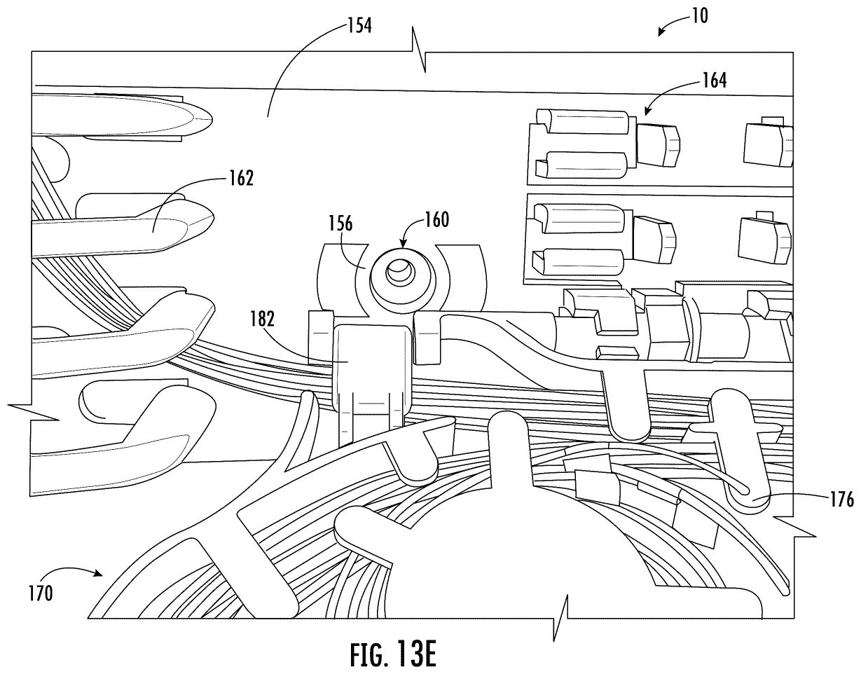

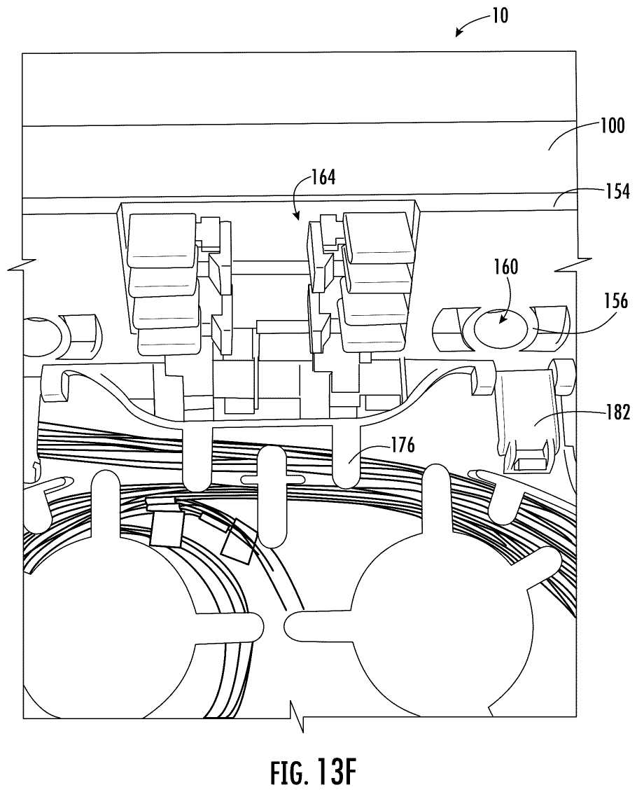

FIG. 13A depicts an exemplary embodiment of a tray 170 attached to a fastener assembly 150. The fastener assembly 150 depicted in FIG. 13A may be configured substantially such as depicted and described in regard to FIG. 12. FIG. 13B further depicts exemplary details of the tray-fastener assembly. FIG. 13C provides a perspective view of an exemplary embodiment of a tray 170. FIG. 13D provides an exploded view of the exemplary embodiment of the tray 170 of FIG. 13C. FIGS. 13E-13F provide detailed views of the exemplary embodiment of tray 170 of FIG. 13A.

Referring to FIGS. 13A-13F, tray 170 includes a base 174 forming an interior volume at which a telecommunications device 178 may be positioned (e.g., splitter, splicer, multiplexer, etc.). Routing features 176 may include tabs and walls in the interior volume for managing fibers or cables routed through and within the tray 170. A cover 180 may be selectively positioned over the base 174 to enclose the interior volume. The base 174 includes mount member 172 at which tray 170 may selectively attach to the fastener assembly 150 in pivotable arrangement such as described herein.

In some embodiments, tray 170 includes a clamp 182 configured to receive and fasten fibers or cables to the base 174. Clamp 182 may include a pivotable clamp wall forming a passage through which fibers or cables can extend through.

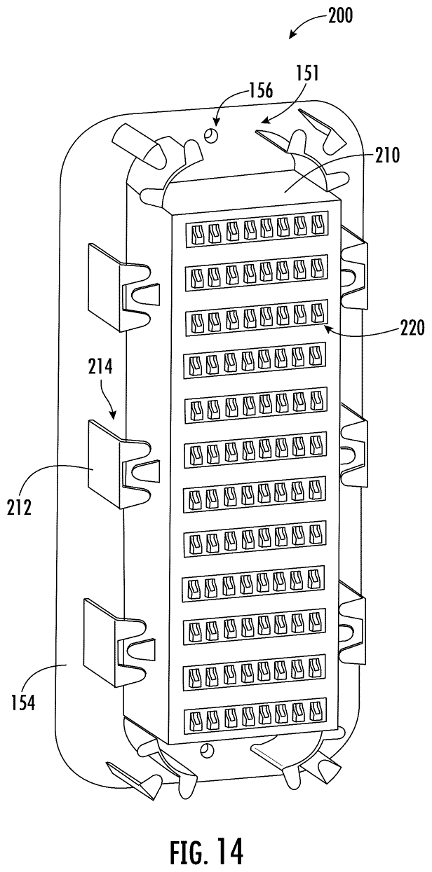

Referring now to FIG. 14, embodiments of the modular cassette chassis assembly 200 may be formed from one molded plastic component. The modular cassette chassis assembly 200 may include a body or chassis 210 for mounting one or more optical cassette modules 220. An integrated cable manager may include a wall or tab 212 forming a pathway 214 for routing cables. The modular cassette chassis assembly 200 includes the fastener assembly 150, such as the mount wall 154 and member 156 described herein. For instance, the fastener assembly 150 may form a drop-in male fixing point for assembly to the backboard 100. In various embodiments, different configurations of the chassis assembly 200 may be utilized to receive different optical cassette modules, such as based on user requirements.

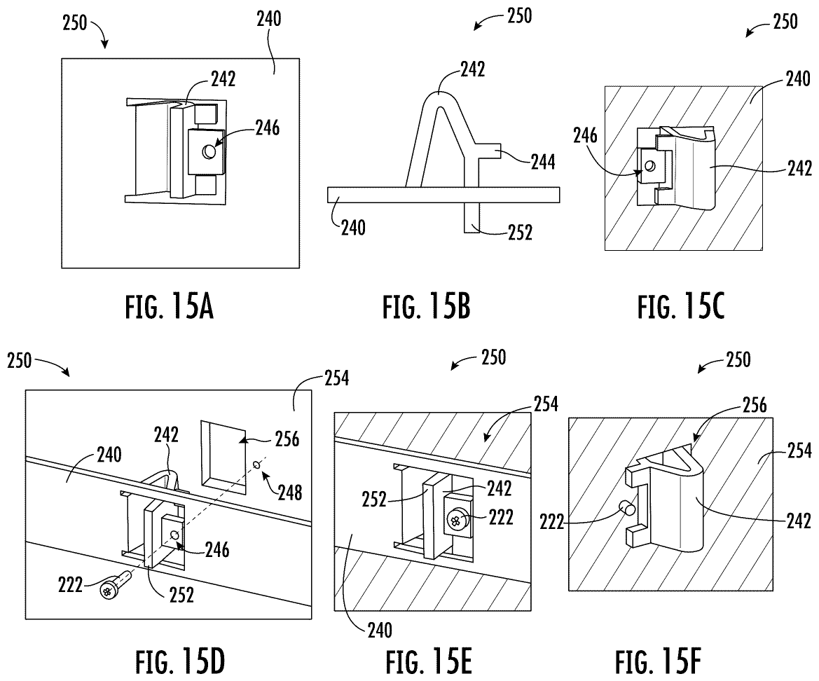

Referring now to FIGS. 15A-15F, an embodiment of a fastener assembly 250 and fixing method are provided. In an embodiment, a backboard 240 includes a body 242 (e.g., a male interface) extending from the backboard 240. A mount wall 254 (e.g., at the modular cassette chassis assembly 200 or splitter/cassette optical body, etc.) includes an opening 256 to receive the body 242 from the backboard 240. In some embodiments, the body 242 includes a deformable clip configured to extend into the opening 256. In some embodiments, the body 242 may include a male snap fit latch. The body 242 forming the snap fit latch may include a plastic deformable latch (e.g., a substantially V-shaped latch) including a rear latching face 244. The body 242 forming the latch may include a front face opening 246 (e.g., a front face bore) configured to receive a mechanical fastener 222 (e.g., a screw, rod, shank, threaded shank, locking screw, etc.). The opening 256 at the mount wall 254 may include a substantially rectangular shape or other appropriate geometry. The mount wall 254 may include a fastener opening 248 (e.g., a bore) configured to receive the fastener 222. The body 242 forming a latch may include an arm 252 protruding through the backboard 240. A user may depress the body 242 forming the latch (e.g., at the arm 252 or at the V-shaped latch) and push into the opening 256, causing engagement of the latch at the rear latching face 244. Openings 246, 248 are aligned to accept the fastener 222, such as may inhibit movement of the latch from being operated to decouple the fastener assembly 250.

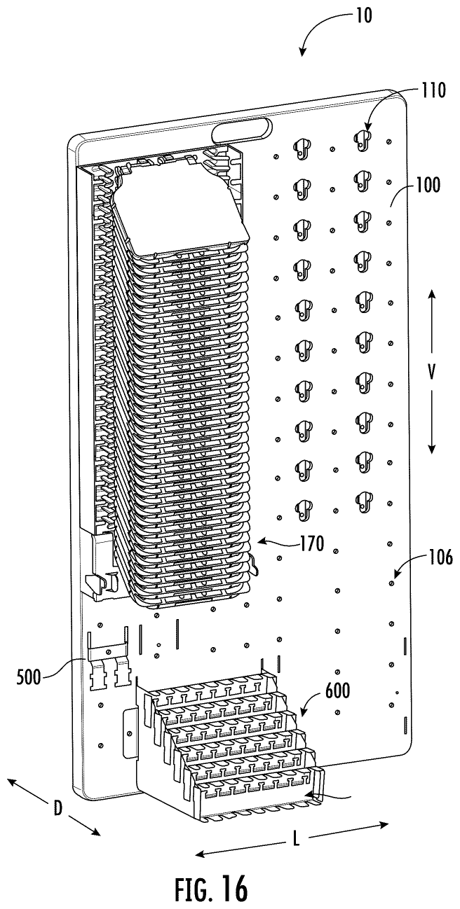

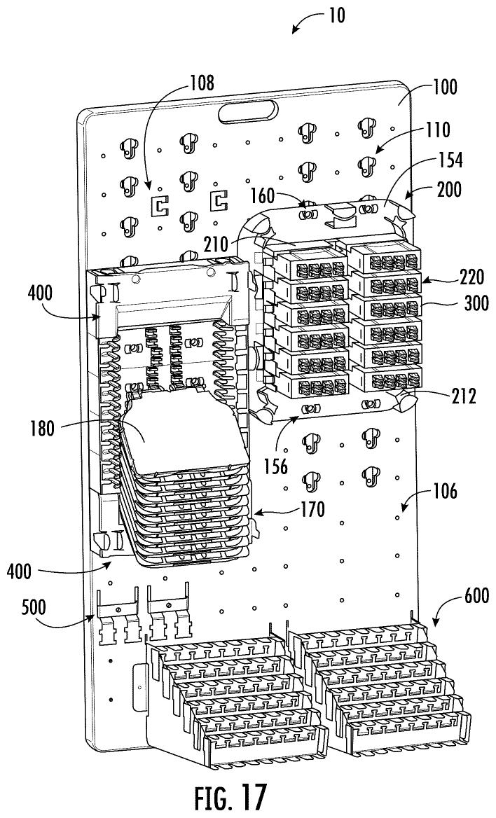

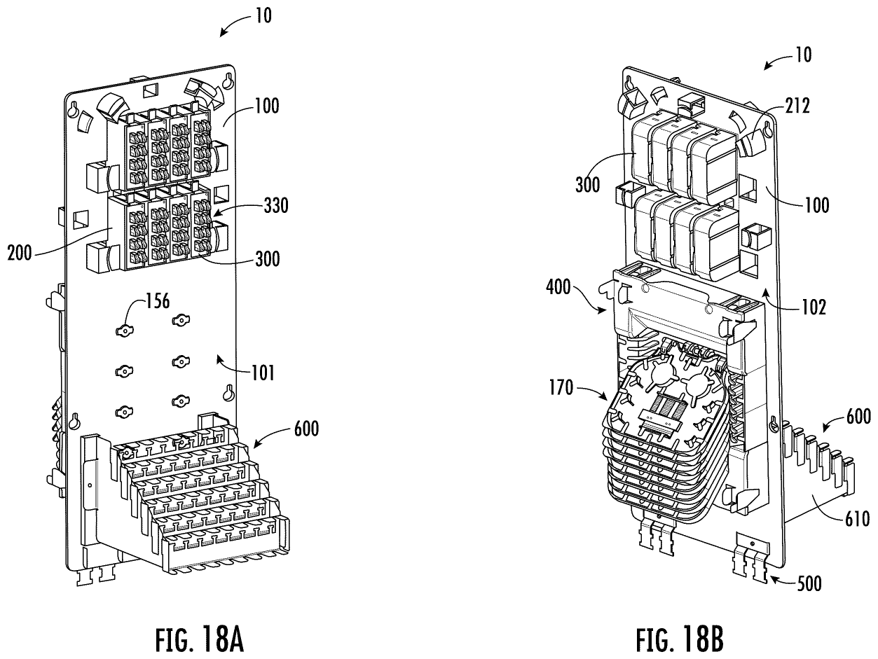

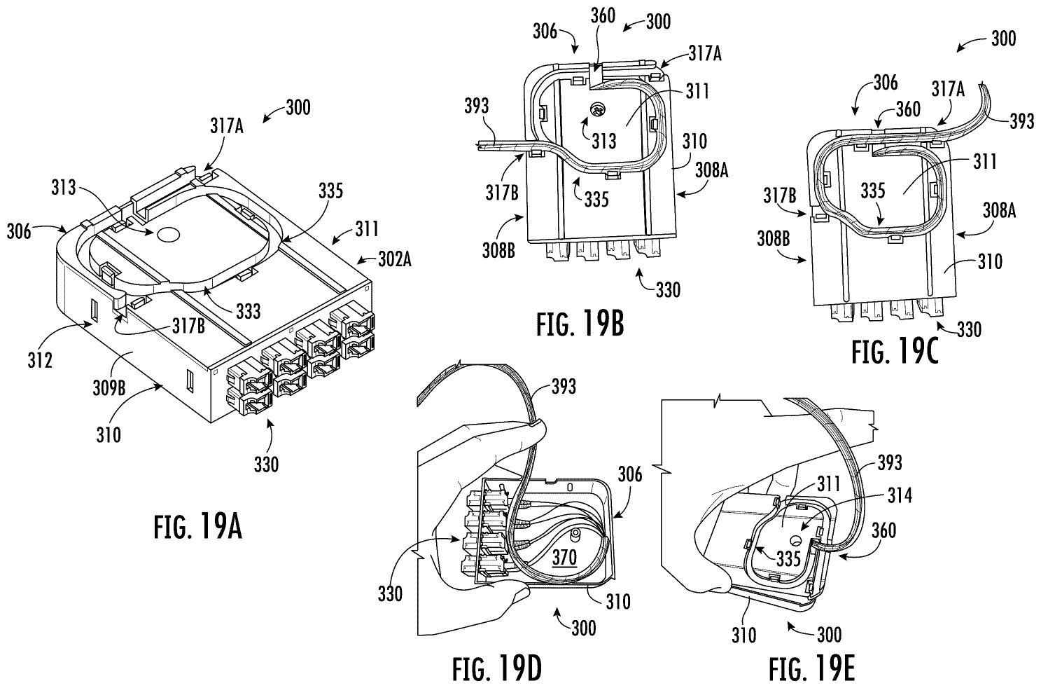

FIGS. 16-17 and FIGS. 18A-18B depict various exemplary embodiments of a backboard assembly 10 in accordance with aspects of the present disclosure. FIG. 18A depicts an exemplary embodiment of a backboard assembly 10 from a front view in accordance with aspects of the present disclosure. FIG. 18B depicts the embodiment of FIG. 18A from a back/rear view. Embodiments of the backboard assembly 10 may further include mechanical fastener locations 106 and slots 108 for wraps, ties, bands, straps, etc. Embodiments depicted various configurations of trays 170, such as splitter or splice trays, raceways, mount interfaces, chassis, modules, and cassettes, such as further depicted and described in regard to FIGS. 19-23.

FIGS. 19A-19E provide views of an exemplary cassette module 300 for embodiments of the backboard assembly 10 provided herein. Embodiments of the cassette module 300 depicted in FIGS. 19A-19E may be included at the embodiment of the backboard assembly 10 depicted at FIGS. 18A-18B. FIG. 19A provides a perspective view of the cassette module 300. FIGS. 19B-19C depict exemplary routing methods through a passage 335 at a cover plate 311 of the cassette 300 from a first side 308A and a second side 308B (e.g., corresponding to a front side 101 and a rear side 102 of the backboard assembly 10) and through a passthrough-opening 360 into an internal volume 370 (FIG. 19D). FIG. 19D depicts an exemplary interior volume 370 of the cassette module 300. FIG. 19E depicts an exemplary perspective view of the cassette module 300.

The cassette 300 includes a main body 310 configured to retain fiber optic adapter wall 330 (e.g., wall 330 including a plurality of fiber optic adapters (such as, but not limited to, LC, SC, MPO, MDC, SN, etc. adapters). A fiber slack storage area is formed at interior volume 370 of the main body 310. The main body 310 includes a pair of sidewalls 308A, 308B separated from one another along a length. The main body 310 includes an end wall 306 extending between the sidewalls 308A, 308B along a width. The end wall 306 and the sidewalls 308A, 308B extend along a height. Interior volume 370 is formed between end wall 306 and sidewalls 308A, 308B. It should be appreciated that the length, the width, and the height may extend along mutually orthogonal axes. The adapter wall 330 extends between sidewalls 308A, 308B. The end wall 306 is positioned opposite along the length of the adapter wall 330.

The main body 310 may form a unitary, monolithic component. For instance, the main body 310 may be formed as a single molded main body. Any appropriate manufacturing method may be utilized to form the main body 310 as a unitary, monolithic component, such as, but not limited to, molding, extrusion, or additive manufacturing.

The cassette module 300 includes a cover 311 providing a base wall and/or a top wall at the main body 310, such as to enclose the interior volume 370. Cover 311 is removably disposable onto main body 310, such as selectively attached and released via latches, clips, fasteners, or other attachment mechanisms (e.g., via fastener opening 313 formed at cover 311 and fastener opening 314 at body 310).

Cable entry passages 317A, 317B are formed at sidewalls 308A, 308B. Cable openings or passages 317A, 317B are formed to allow for front and/or rear entry (or side and opposing side entry) of the cable 393, or portions thereof (e.g., splitter routing tails or other optical fiber portions) into cable passage 335 and interior volume 370. Cover 311 includes a passage wall 333 at which a routing passage 335 extends between cable entry passages 317A, 317B. The routing passage 335 extends to a passthrough opening 360 extending through the cover 311 (FIG. 19B, 19C, 19E) to the storage area at interior volume 370 (FIG. 19D). Routing passage 335 may form a curved or serpentine conduit, or, furthermore, branch off in a plurality of conduit sections from the cable passages 317A, 317B.

Embodiments of the cassette module 300 permit cable entry through passage 317A at a first side (e.g., FIG. 19C) and cable entry through passage 317B at a second side (e.g., FIG. 19B), and further routing into interior volume 370 (FIG. 19D) through passthrough opening 360 (FIG. 19E).

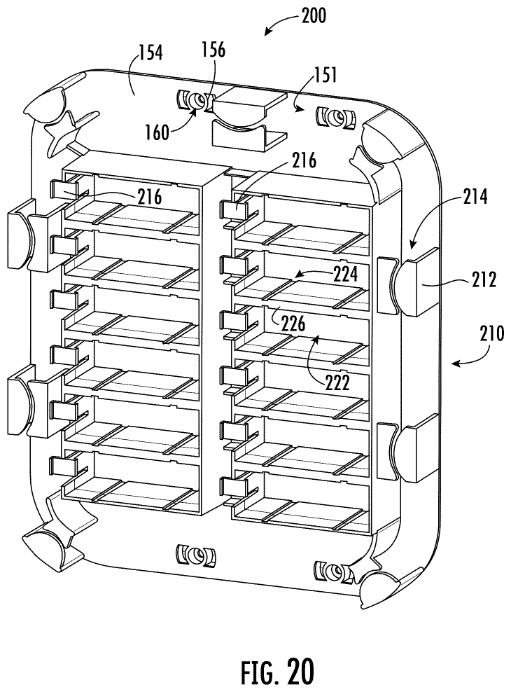

FIG. 20 depicts an exemplary embodiment of a cassette chassis 200, such as may be configured to accommodate exemplary embodiments of the cassette module 300 depicted and described in regard to FIGS. 19A-19E, and mounted to the exemplary backboard assembly 10 of FIGS. 18A-18B. Referring briefly to FIG. 19A, a retainer latch opening 312 at the body 310 is configured to receive a latch member 216 (FIG. 20) of the cassette chassis 200. Chassis or body 210 forms a cassette port 222 configured to receive the cassette module 300. A wall 226 forms a groove 224 at which cables or fibers may be positioned, such as to facilitate passing fiber through the body 210. When mounted to the backboard 100, body 210 further facilitates passing fiber through the backboard 100 between first side 101 and second side 102.

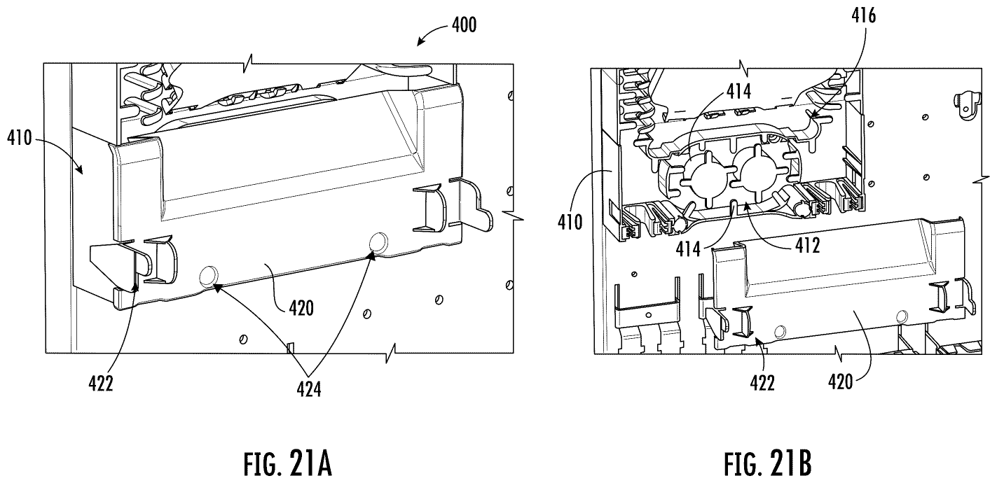

FIGS. 21A-21B depict an exemplary embodiment of a cable manifold 400, such as may be included at embodiments of the backboard assembly 10 depicted and described herein. Embodiments of the cable manifold 400 may include a base 410 at which an internal volume 412 is formed. A plurality of tabs and walls 414 extend within the internal volume 412 to form passages 416 along which cables or fibers may be routed and organized. A removable cover 420 is selectively attachable to the base 410, such as retention and release latches 422. Fastener openings 424 may be configured to receive a fastener through the cover 420 to attach to base 410.

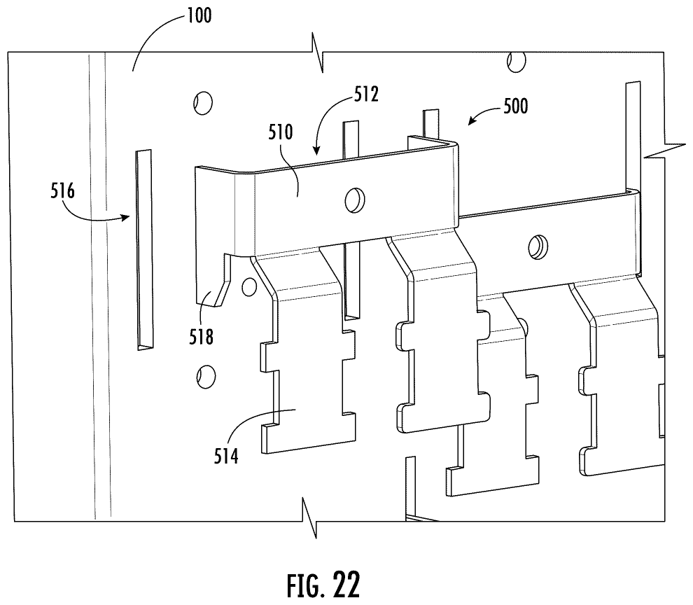

FIG. 22 depicts an exemplary embodiment of a duct tie interface 500 for embodiments of the backboard assembly 10 depicted and described herein. The duct tie interface 500 may include walls or buckles 510 forming a passage 512 through which cables or fibers are extendable. Retainer and organizer members 514 extend from the walls 510 to provide surfaces at which a tie wrap, band, or other retainer device may attach to the interface 500. Backboard 100 may include a slot 516 at which a slot member 518 extending from the wall 510 is receivable, such as to form a drop-in mount for the interface 500 to selectively attach to the backboard 100.

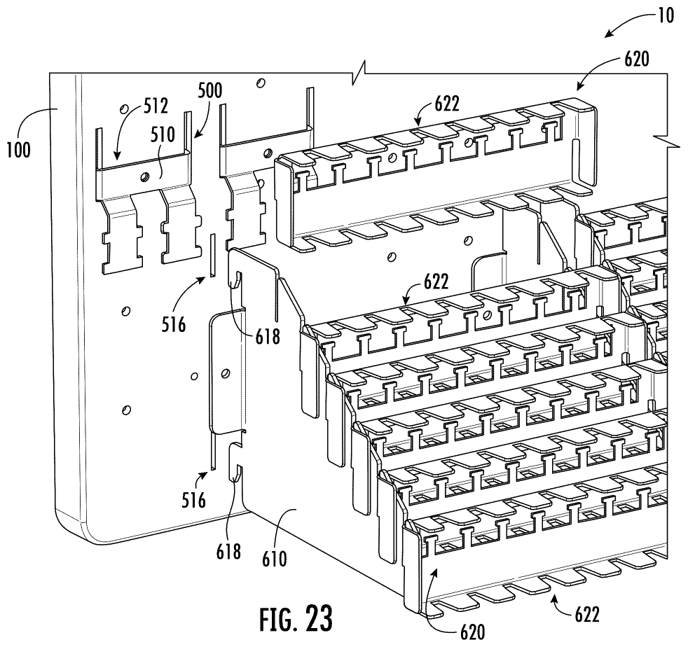

FIG. 23 depicts an exemplary embodiment of a cable manager 600 for embodiments of the backboard assembly 10 depicted and described herein. Cable manager 600 may include a stairway body 610 configured to receive a plurality of channel assemblies 620 in adjacent vertical arrangement. The body 610 further separates the channel assemblies 620 along a depth direction, such as to position channels 622 separate from one another along the depth direction D. The body 610 may include a slot member 618 to drop into slot 518, such as described in regard to the interface 500 at FIG. 22.

Aspects of the present disclosure include a backboard assembly and fastener assembly for telecommunications equipment mounting, methods for fastening telecommunications equipment to a surface, a cassette module, and a cassette module assembly including a cassette module and a cassette chassis.

Embodiments provided herein, including the backboard 100, fastener assembly 150, and backboard assembly 10, may significantly reduce assembly and manufacturing time and cost in contrast to known mount and cabinet apparatuses. Embodiments provided herein may facilitate reducing component costs, such as by including the modular cassette chassis with integrated cable managers, facilitating fewer components, and reduced assembly time. Embodiments provided herein facilitate a relatively high degree of configuration flexibility using common components. Shared or common configuration backboard may facilitate lower investment costs (e.g., by using shared backboard across a plurality of configurations). Partial-width backboard may further increase configuration flexibility.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A backboard assembly for telecommunications equipment mounting, the backboard assembly comprising:
a backboard comprising a wall through which an opening is formed, wherein the opening forms an elongated slot, and wherein a face forming a detent is positioned offset from the opening and the wall;
a fastener assembly comprising a mount wall, wherein a member extends from the mount wall toward the opening at the backboard, wherein the member comprises a wing extending co-directional to the wall at the opening of the backboard, wherein the wing positions between the face and the wall when the member of the fastener assembly is extended through the opening of the backboard.

2. The backboard assembly of claim 1, wherein the opening forms the elongated slot extending along a vertical direction between a top end and a bottom end, and wherein the opening forms a keyhole extending along a lateral direction from the top end.

3. The backboard assembly of claim 2, wherein the wing of the fastener assembly corresponds in extension along the lateral direction to the keyhole of the opening of the backboard.

4. The backboard assembly of claim 2, wherein the face extends along the vertical direction from the bottom end to the top end of the opening forming the elongated slot extending along the vertical direction.

5. The backboard assembly of claim 4, wherein the wing positions between the face and the wall when the member of the fastener assembly is extended through the opening and translated along the vertical direction to the bottom end of the opening of the backboard.

6. The backboard assembly of claim 5, wherein the face is offset from the wall corresponding to a thickness of the wing of the fastener assembly to form an interference fit when the wing positioned between the face and the wall.

7. The backboard assembly of claim 1, wherein the face comprises a fastener opening configured to receive a fastener extending through the member of fastener assembly.

8. The backboard assembly of claim 7, wherein the fastener opening is positioned along a vertical direction proximate to a bottom end of the opening forming the elongated slot extending along the vertical direction.

9. The backboard assembly of claim 1, comprising:
a splice tray, wherein the splice tray comprises a tray mount wall at which the mount wall of the fastener assembly is positioned.

10. The backboard assembly of claim 1, comprising:
a cable manifold, wherein the cable manifold comprises a manifold mount wall at which the mount wall of the fastener assembly is positioned.

11. The backboard assembly of claim 1, comprising:
a cassette chassis, wherein the cassette chassis comprises a chassis mount wall at which the mount wall of the fastener assembly is positioned.

12. The backboard assembly of claim 11, wherein the backboard comprises a cassette chassis opening configured to receive cassette chassis, wherein the cassette chassis comprises a port through which a cassette is extendable to position the cassette through the backboard.

13. The backboard assembly of claim 1, wherein the wall of the backboard comprises a front side and a rear side, and wherein the mount wall of the fastener assembly comprises a front side and a rear side, wherein the member extends from the rear side of the mount wall, and wherein the rear side of the mount wall abuts the front side of the wall of the backboard when the wing positions between the face and the wall of the backboard.

14. The backboard assembly of claim 13, wherein the face extends from the rear side of the wall of the backboard.

15. The backboard assembly of claim 14, comprising:
a fastener extendable from the front side of the mount wall through the member into a fastener opening at the face.

16. The backboard assembly of claim 13, wherein the mount wall of the fastener assembly comprises a mount mechanism positioned at the front side.

17. The backboard assembly of claim 13, wherein the mount wall of the fastener assembly comprises a raceway configured to guide a telecommunications line.

18. The backboard assembly of claim 1, wherein the member comprises a tube, wherein the wing extends along a lateral direction from the tube.

19. The backboard assembly of claim 18, wherein the tube corresponds in outer dimension to the opening forming the elongated slot extending along a vertical direction.

20. The backboard assembly of claim 19, wherein the wing corresponds in extension along a lateral direction to a keyhole of the opening of the backboard, and wherein the wing extends along the lateral direction greater than the outer dimension of the tube.
